(19) United States
(12) Patent Application Publication
(10) Pub. No.: US 2015/0287384 A1
(43) Pub. Date: Oct. 8, 2015

(54) METHOD OF CONFIGURING MAP AND ELECTRONIC DEVICE THEREOF

(71) Applicant: Samsung Electronics Co., Ltd., Suwon-si (KR)

(72) Inventor: Marcin MASTERNAK, Warsaw (PL)

(21) Appl. No.: 14/681,277

(22) Filed: Apr. 8, 2015

(30) Foreign Application Priority Data
Apr. 8, 2014 (KR) 10-2014-0041635

(51) Int. Cl. G09G 5/00; G09G 5/373; G09G 5/37

(52) U.S. Cl. CPC G09G 5/005; G09G 5/37; G09G 5/373; G09G 2354/00; G09G 2340/045; G09G 2340/0464; G09G 2320/10; G09G 2360/02

(57) ABSTRACT

A device and method for configuring a map in an electronic device is provided. The method includes determining, by one or more processors of the electronic device, a display format of internal maps for respective floors of a building when an event for displaying the internal maps of the building constructed with multiple floors occurs, and displaying the internal maps for the respective floors of the building without overlapping each other based on the determined display format.

### CROSS-REFERENCE TO RELATED APPLICATION(S)

This application claims the benefit under 35 U.S.C. §119(a) of a Korean patent application filed on Apr. 8, 2014 in the Korean Intellectual Property Office and assigned Serial number 10-2014-0041635, the entire disclosure of which is hereby incorporated by reference.

### TECHNICAL FIELD

The present disclosure relates to a device and method for configuring internal maps for respective floors of a building in an electronic device.

### BACKGROUND

Electronic devices have developed into multimedia devices that provide various services such as voice and video call functions, information input/output functions, and data transmission/reception functions.

Among the various services provided by the electronic devices, a map service is frequently used for a user to find a path from a starting point to a destination, or to identify, in advance, a place to visit. In addition, the user may also obtain surrounding information based on the current location.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a device and method for configuring a map in an electronic device.

Another aspect of the present disclosure is to provide a device and method for configuring an internal map of a building in an electronic device.

Another aspect of the present disclosure is to provide a device and method for configuring internal maps for respective floors of a building in an electronic device.

Another aspect of the present disclosure is to provide a device and method for displaying internal maps for respective floors of a building without overlapping each other in an electronic device.

Another aspect of the present disclosure is to provide a device and method for displaying internal maps for respective floors of a building, without overlapping each other, together with a moving path in an electronic device.

Another aspect of the present disclosure is to provide a device and method for magnifying and displaying internal maps for respective floors of a building in an electronic device.

Another aspect of the present disclosure is to provide a device and method for moving and displaying internal maps for respective floors of a building in an electronic device.

In accordance with an aspect of the present disclosure, a method of an electronic device configuring a map is provided. The method includes determining, by one or more processors of the electronic device, a display format of internal maps for respective floors of a building when an event for displaying the internal maps of the building constructed with multiple floors occurs, and displaying the internal maps for the respective floors of the building without overlapping each other based on the determined display format.

In accordance with another aspect of the present disclosure, the determining of the display format of the internal maps for the respective floors of the building may include determining tilts of the internal maps for the respective floors of the building.

In accordance with another aspect of the present disclosure, the determining of the display format of the internal maps for the respective floors of the building may include determining relative positions of the internal maps for the respective floors of the building.

In accordance with another aspect of the present disclosure, the method may further include displaying an internal map for a selected floor, when one floor is selected from the displayed internal maps for the respective floors of the building.

In accordance with another aspect of the present disclosure, the method may further include displaying an internal map for a floor above or below the selected floor based on a direction of a drag when the drag is generated on the internal map of the selected floor.

In accordance with another aspect of the present disclosure, the method may further include magnifying and displaying internal maps for some floors of the building based on a magnification level when an event for magnifying the internal maps for the respective floors of the building occurs.

In accordance with another aspect of the present disclosure, the method may further include displaying an internal map for a floor above or below displayed floors of the building based on a direction of a drag, when the drag is generated on the magnified internal maps for the floors of the building.

In accordance with another aspect of the present disclosure, the method may further include, when an event for finding a path involving the building occurs, displaying the internal maps for the respective floors of the building, without overlapping each other, together with a moving path of the event for finding the path.

In accordance with another aspect of the present disclosure, the method may further include cancelling the displaying of the internal images for the floors which are not involved in the moving path among all the floors of the building.

In accordance with another aspect of the present disclosure, an electronic device is provided. The electronic device includes a display, a memory, and one or more processors configured to determine a display format of internal maps for respective floors of a building when an event for displaying the internal maps of the building constructed with multiple floors occurs, and to display, on the display, the internal maps for the respective floors of the building without overlapping each other based on the determined display format.

In accordance with another aspect of the present disclosure, the one or more processors may be further configured to determine tilts of the internal maps for the respective floors of the building.

In accordance with another aspect of the present disclosure, the one or more processors may be further configured to determine relative positions of the internal maps for the respective floors of the building.

In accordance with another aspect of the present disclosure, when one floor is selected from the internal maps for the respective floors of the building which are displayed on the display, the one or more processors may be further configured to display an internal map of the selected floor on the display.

In accordance with another aspect of the present disclosure, the one or more processors may be further configured to display, on the display, an internal map for a floor above or below the selected floor based on a direction of a drag, when the drag is generated on the internal map of the selected floor.

In accordance with another aspect of the present disclosure, the one or more processors may be further configured to magnify and display internal maps for some floors of the building through the display based on a magnification level when an event for magnifying the internal maps for the respective floors of the building occurs.

In accordance with another aspect of the present disclosure, the one or more processors may be further configured to display, through the display, an internal map for a floor above or below displayed floors of the building based on a direction of a drag when the drag is generated on the magnified internal maps for the floors of the building.

In accordance with another aspect of the present disclosure, when an event for finding a path involving the building occurs, the one or more processors may be further configured to display, through the display, the internal maps for the respective floors of the building without overlapping each other, together with a moving path of the event for finding the path.

In accordance with another aspect of the present disclosure, the one or more processors may be further configured to cancel, through the display, the displaying of the internal images for the floors which are not involved in the moving path among all the floors of the building.

In accordance with another aspect of the present disclosure, a non-transitory computer-readable recording medium is provided. The non-transitory computer-readable recording medium storing instructions that, when executed, cause at least one processor to perform a method including determining a display format of internal maps for respective floors of a building when an event for displaying the internal maps of the building constructed with multiple floors occurs, and displaying the internal maps for the respective floors of the building without overlapping each other based on the determined display format.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device according to an embodiment of the present disclosure;

FIG. 2 is a detailed block diagram of a processor according to an embodiment of the present disclosure;

FIG. 3 is a flowchart illustrating a procedure for displaying internal maps for respective floors of a building without overlapping each other in an electronic device according to an embodiment of the present disclosure;

FIG. 4 is a flowchart illustrating a procedure for magnifying and displaying internal maps for some floors of a building in an electronic device according to an embodiment of the present disclosure;

FIGS. 5A, 5B, and 5C illustrate screen configurations for magnifying and displaying internal maps for some floors of a building in an electronic device according to various embodiments of the present disclosure;

FIG. 6 is a flowchart illustrating a procedure for displaying an internal map for one floor among internal maps for respective floors of a building in an electronic device according to an embodiment of the present disclosure;

FIGS. 7A and 7B illustrate screen configurations for displaying an internal map for any floor among internal maps for respective floors of a building in an electronic device according to various embodiments of the present disclosure;

FIG. 8 is a flowchart illustrating a procedure for controlling a movement of internal maps for respective floors of a building in an electronic device according to an embodiment of the present disclosure;

FIGS. 9A and 9B illustrate screen configurations for controlling movement of internal maps for respective floors of a building in an electronic device according to various embodiments of the present disclosure;

FIG. 10 is a flowchart illustrating a procedure for displaying internal maps for respective floors of a building together with a moving path in an electronic device according to an embodiment of the present disclosure;

FIGS. 11A, 11B, and 11C illustrate screen configurations for displaying internal maps for respective floors of a building together with a moving path in an electronic device according to various embodiments of the present disclosure;

FIG. 12 illustrates a screen configuration for determining a size of a map boundary based on areas and relative positions of internal maps for respective floors of a building in an electronic device according to an embodiment of the present disclosure;

FIG. 13 illustrates a screen configuration for displaying internal maps for respective floors of a building without overlapping each other in an electronic device according to an embodiment of the present disclosure;

FIG. 14 illustrates a procedure for determining a display format of an internal map according to tilts of internal maps for respective floors of a building according to an embodiment of the present disclosure;

FIG. 15 illustrates a procedure for determining a display format of an internal map according to tilts of internal maps for respective floors of a building according to an embodiment of the present disclosure; and

FIG. 16 illustrates a procedure for determining a display format of an internal map according to tilts of internal maps for respective floors of a building according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, the expressions “include” and/or “may include” refer to the existence of a corresponding function, operation, and/or element, and do not limit one or more additional functions, operations, and/or elements. Also, as used herein, the terms “include” and/or “have” should be construed to denote existence of a certain feature, number, operation, element, component or a combination thereof, and should not be construed to exclude the existence or possible addition of one or more other features, numbers, operations, elements, components, or combinations thereof.

Also, as used herein, the expression “or” includes any or all combinations of words enumerated together. For example, the expression “A or B” may include A, may include B, and/or may include both A and B.

Herein, the expressions “a first,” “a second,” “the first,” “the second,” and the like may modify various elements, but the corresponding elements are not limited by these expressions. For example, the above expressions do not limit the sequence and/or importance of the corresponding elements. The above expressions may be used merely for the purpose of distinguishing one element from other elements. For example, a first user device and a second user device indicate different user devices although both of them are user devices. For example, a first element may be referred to as a second element, and similarly, a second element may be referred to as a first element without departing from the scope of the embodiments of the present disclosure.

When an element is referred to as being “coupled” and/or “connected” to any other element, it should be understood that not only the element may be directly coupled or connected to the other element, but also a third element may be interposed therebetween. By contrast, when an element is referred to as being “directly coupled” and/or “directly connected” to any other element, it should be understood that no element is interposed therebetween.

The terms used in the following description are used to describe specific embodiments, and are not intended to limit embodiments of the present disclosure. As used herein, the singular forms are intended to include the plural forms as well, unless the context clearly indicates otherwise.

Unless defined otherwise, all terms used herein, including technical and scientific terms, have the same meaning as those commonly understood by a person of ordinary skill in the art to which the embodiments of the present disclosure pertain. Such terms as those defined in a generally used dictionary are to be interpreted to have definitions equivalent to the contextual definitions in the relevant field of the art, and are not to be interpreted to have ideal or excessively formal meanings unless clearly defined herein.

For example, the above-mentioned electronic device may be one or a combination of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), a Motion Picture Experts Group (MPEG) Audio Layer 3 (MP3) player, a mobile medical device, an electronic bracelet, an electronic necklace, an electronic appcessory, a camera, a wearable device, an electronic clock, a wrist watch, a home appliance (e.g., a refrigerator, an air conditioner, a cleaner, an artificial intelligence robot, a TeleVision (TV), a Digital Video Disc (DVD) player, an audio player, an oven, a microwave oven, a washing machine, an air cleaner, and an electronic picture frame), various types of medical devices (e.g., a Magnetic Resonance Angiography (MRA) device, a Magnetic Resonance Imaging (MRI) device, a Computed Tomography (CT), scanner, an ultrasonic device, and the like), a navigation device, a Global Positioning System (GPS) receiver, an Event Data Recorder (EDR), a Flight Data Recorder (FDR), a set-top box, a TV box (e.g., Samsung HomeSync™, Apple TV™, and/or Google TV™), an electronic dictionary, a vehicle infotainment device, electronic equipment for a ship (e.g., a navigation device for ship, a gyro compass, and the like), avionic equipment, a security device, electronic clothes, an electronic key, a camcorder, a game console, a Head-Mounted Display (HMD), a flat panel display device, an electronic frame, an electronic album, furniture or a part of buildings/structures having a communication function, an electronic board, an electronic signature receiving device, a wearable device, and a projector. It is obvious to those skilled in the art that the electronic device according to the present disclosure is not limited to the aforementioned devices.

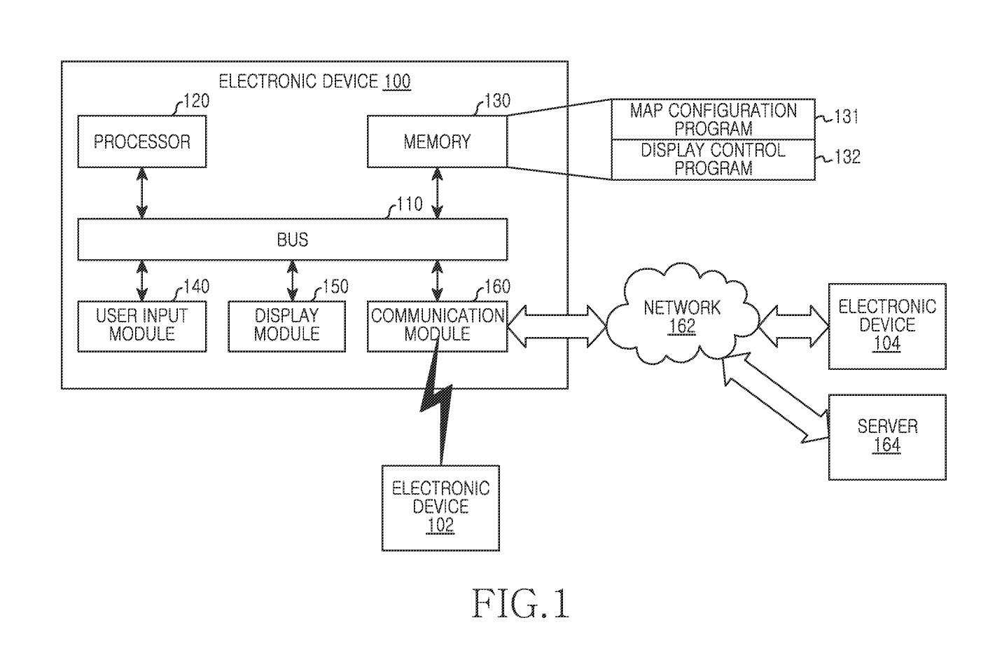

FIGS. 1 through 16, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element.

FIG. 1 is a block diagram of an electronic device according to an embodiment of the present disclosure.

Referring to FIG. 1, an electronic device 100 is illustrated, where the electronic device may include a bus 110, a processor 120, a memory 130, a user input module 140, a display module 150, and a communication interface 160.

The bus 110 may be a circuit that interconnects the elements included in the electronic device 100 (e.g., the processor 120, the memory 130, the user input module 140, the display module 150, and the communication interface 160) and transfers communication (e.g., a control message) between the elements.

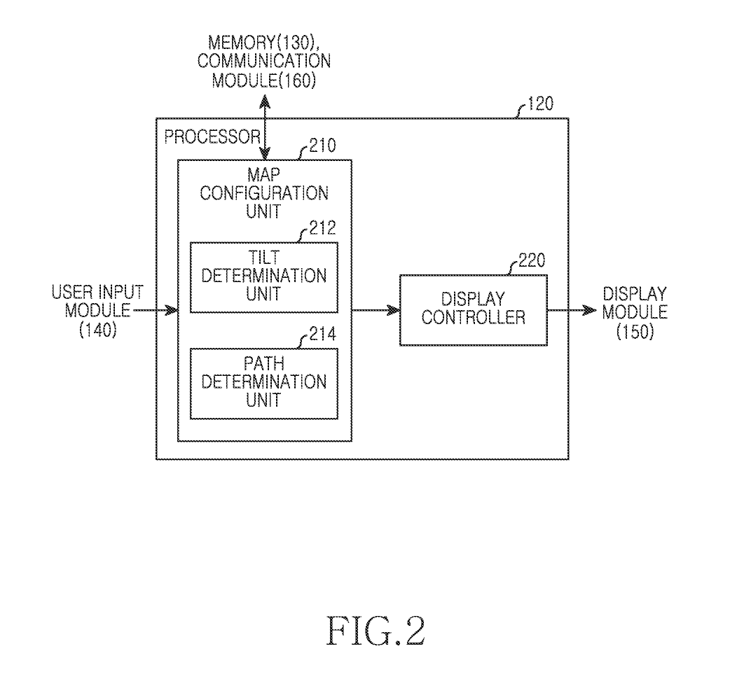

The processor 120 may receive instructions through the bus 110 from the elements included in the electronic device 100, decode the received instructions, and perform calculations and/or data processing according to the decoded instructions. In this case, the processor 120 may execute at least one application stored in the memory 130 to provide a service according to the corresponding application. For example, the processor 120 may be constituted as illustrated in FIG. 2 to configure internal maps for respective floors of a building by executing a map configuration program 131 and a display control program 132.

The processor 120 may include one or more Application Processors (APs) or one or more Communication Processors (CPs). Here, the APs and the CPs may be included in the processor 120 or may be included in different integrated circuit (IC) packages, respectively. Alternatively, the APs and the CPs may also be included in one IC package. The APs may control a plurality of hardware or software elements connected thereto by driving an operating system or application programs and perform data processing and calculations of various types of data including multimedia data. The APs may be implemented as a System on Chip (SoC). The CPs may perform at least some multimedia control functions. In addition, the CPs may distinguish between and authenticate terminals in a communication network, using a subscriber identification module (SIM) (e.g., a SIM card). The CPs may provide a user with services including a voice call, a video call, a text message, or packet data. Furthermore, the CPs may control data transmission and reception of the communication interface 160. The APs or the CPs may load, in volatile memories, instructions or data received from at least one of the non-volatile memories connected thereto or the other elements to process the instructions or data. The APs or the CPs may store data received from or generated by at least one of the other elements in non-volatile memories. The CPs may perform a function of managing a data link and switching communication protocols in communication between the electronic device including hardware and other electronic devices connected thereto through a network. The CPs may be implemented as an SoC. Additionally, the processor 120 may further include a Graphic Processing Unit (GPU).

The memory 130 may store instructions and/or data received from and/or generated by the processor 120 and/or the other elements (e.g., the user input module 140, the display module 150, and the communication module 160). In this case, the memory 130 may include an internal buffer and an external buffer.

In addition, the memory 130 may include the map configuration program 131 and the display control program 132. In this case, each application may include programming modules, and each of the programming modules may include software, firmware, hardware, or a combination of two or more thereof.

The map configuration program 131 may include at least one software element for configuring internal maps for respective floors of a building. For example, when an event for displaying internal maps of a building occurs, the map configuration program 131 may determine a display format of the internal maps for the respective floors of the building. Thereafter, the map configuration program 131 may display the internal maps for the respective floors of the building without overlapping each other through the display control program 132.

In cases where an event for magnifying the maps for some floors of the building occurs, the map configuration program 131 may magnify and display the internal maps for the floors of the building based on a magnification level through the display control program 132. In addition, in cases where an event for selecting any floor of the building occurs, the map configuration program 131 may display the internal map for the corresponding floor through the display control program 132. Furthermore, in cases where an event for moving the internal maps of the building occurs, the map configuration program 131 may update the displaying of the internal maps for the respective floors of the building based on a moving distance through the display control program 132. Moreover, in cases where an event for finding a path occurs, the map configuration program 131 may display the internal maps for the respective floors of the building without overlapping each other, together with a moving path through the display control program 132.

The display control program 132 may include at least one software element for making a control to display at least one piece of display data through the display module 150. For example, the display control program 132 may display the internal maps for the respective floors of the building without overlapping each other through the display module 150 under the control of the map configuration program 131.

In addition, the display control program 132 may magnify and display the internal maps for the respective floors of the building through the display module 150 under the control of the map configuration program 131. Furthermore, the display control program 132 may display the internal maps for the respective floors of the building without overlapping each other, together with a moving path through the display module 150 under the control of the map configuration program 131.

The memory 130 may include an internal memory and/or an external memory. The internal memory may include at least one of a volatile memory (e.g., a Dynamic Random Access Memory (DRAM), a Static RAM (SRAM), and/or a Synchronous Dynamic RAM (SDRAM)) and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a not and (NAND) flash memory, and/or a not or (NOR) flash memory). In this case, the internal memory may have a shape of a Solid State Drive (SSD). The external memory may include at least one of a Compact Flash (CF), a Secure Digital (SD), a Micro Secure Digital (Micro-SD), a Mini Secure Digital (Mini-SD), an extreme Digital (xD), and a memory stick.

The memory 130 may further include a kernel, middleware, applications, and an Application Programming Interface (API). The kernel may control and/or manage the system resources (e.g., the bus 110, the processor 120, and the memory 130) which are used to execute operations or functions implemented in the remaining other programming modules (e.g., the middleware, the API, and the applications). In addition, the kernel may provide an interface through which the middleware, the API, or the applications may access the individual elements of the electronic device 100 to control or manage the elements. The middleware may serve as a relay for allowing the API or the applications to communicate with the kernel to transfer data. Furthermore, the middleware may perform load balancing for operation requests received from at least one application, using a method of assigning, to the operation requests, priorities to use the system resources of the electronic device 100 (e.g., the bus 110, the processor 120, and/or the memory 130). The API corresponds to an interface through which applications can control functions provided from the kernel or the middleware, and may include at least one interface or function for file control, window control, image processing, and/or text control.

The user input module 140 may receive instructions and/or data from a user and transfer the received instructions and/or data to the processor 120 and/or the memory 130 through the bus 110. For example, the user input module 140 may include a touch panel, a pen sensor, a key, and/or an ultrasonic input device. The touch panel may recognize a touch input through at least one of, for example, a capacitive type, a resistive type, an infrared type, and an ultrasonic type. Here, the touch panel may also further include a controller. In the capacitive type, proximity awareness (hovering) as well as a direct touch is possible. The touch panel may further include a tactile layer. In this case, the touch panel may provide a tactile reaction to a user. For example, the pen sensor may be implemented using a same or similar method to receiving a user's touch input and/or using a separate recognition sheet. The key may include, for example, a keypad and/or a touch key. The ultrasonic input device may identify data by detecting an acoustic wave with a microphone of the electronic device through a pen for generating an ultrasonic signal, and may perform wireless recognition.

The display module 150 may display an image, a video, and/or data to a user. The display module 150 may include, for example, a panel and/or a hologram. The panel may be, for example, a Liquid Crystal Display (LCD) or an Active Matrix Organic Light Emitting Diode (AM-OLED). The panel may be implemented to be flexible, transparent, or wearable. Here, the panel may also be constituted as one module together with the touch panel. For example, the hologram may show a three dimensional (3D) image in the air using interference of light. Additionally, the display module 150 may further include a control circuit for controlling the panel or the hologram.

The display module 150 may display data under the control of the display control program 132. The display module 150 may display internal maps for respective floors of a building without overlapping each other under the control of the display control program 132. In addition, the display module 150 may magnify and display the internal maps for the respective floors of the building under the control of the display control program 132. Furthermore, the display module 150 may display internal maps for respective floors of a building without overlapping each other, together with a moving path under the control of the display control program 132.

The communication module 160 may connect communication between the electronic device 100 and other electronic devices 102 and 104. The communication module 160 may support a short-range communication protocol (e.g., Wireless Fidelity (Wi-Fi), Bluetooth (BT), and/or Near Field Communication (NFC)) and/or a network 162 (e.g., the Internet, a Local Area Network (LAN), a Wide Area Network (WAN), a telecommunication network, a cellular network, a satellite network, and/or a Plain Old Telephone Service (POTS)). The network 162 may also connect communication between the communication module 160 and a server 164.

The other electronic devices 102 and 104 may be the same (e.g., the same type of) device as the electronic device 100 or a different (e.g., a different type of) device from the electronic device 100.

Additionally, the electronic device may further include a sensor module. The sensor module may include at least one of a gesture sensor, a gyro sensor, an atmospheric pressure sensor, a magnetic sensor, an acceleration sensor, a grip sensor, a proximity sensor, a Red, Green, and Blue (RGB) sensor, a bio-metric sensor, a temperature/humidity sensor, an illumination sensor, and an Ultraviolet (UV) sensor. The sensor module may measure a physical quantity and/or detect an operating state of the electronic device 100 to convert the measured or detected information into an electric signal. For example, the sensor module may include an E-nose sensor, an electromyography (EMG) sensor, an electroencephalogram (EEG) sensor, an electrocardiogram (ECG) sensor, and/or a fingerprint sensor. The sensor module may further include a control circuit for controlling at least one sensor included therein.

The names of elements of hardware according to various embodiments may vary with the type of the electronic device. The hardware according to the various embodiments of the present disclosure may include at least one of the aforementioned elements, may further include other additional elements, and/or may have some of the aforementioned elements may be omitted. In addition, some elements of the hardware according to the various embodiments may be combined into one entity, which may perform the same functions as the relevant elements before the combination.

FIG. 2 is a detailed block diagram of a processor according to an embodiment of the present disclosure.

Referring to FIG. 2, a processor 120 is illustrated, where the processor 120 may include a map configuration unit 210 and a display controller 220.

The map configuration unit 210 may execute the map configuration program 131 stored in the memory 130, as illustrated in FIG. 1, to control a configuration of internal maps for respective floors of a building. For example, when an event for displaying internal maps of a building occurs, the map configuration unit 210 may determine a display format of the internal maps for the respective floors of the building. Thereafter, the map configuration unit 210 may display the internal maps for the respective floors of the building without overlapping each other through the display controller 220.

In cases where an event for magnifying the maps for some floors of the building occurs, the map configuration unit 210 may magnify and display the internal maps for the floors of the building based on the magnification level through the display controller 220. In addition, in cases where an event for selecting any floor of the building occurs, the map configuration unit 210 may display the internal map for the corresponding floor through the display controller 220.

Furthermore, in cases where an event for moving the internal maps of the building occurs, the map configuration unit 210 may update the displaying of the internal maps for the respective floors of the building based on the moving distance through the display controller 220. Moreover, in cases where an event for finding a path occurs, the map configuration unit 210 may display the internal maps for the respective floors of the building without overlapping each other, together with a moving path through the display controller 220. Additionally, the map configuration unit 210 may also include a tilt determination unit 212 for determining tilts of the internal maps for the respective floors of the building and a path determination unit 214 for determining a path from a starting point to a destination.

The display controller 220 may receive data from the user input module 140 and display data through the display module 150 by executing the display control program 132 stored in the memory 130. For example, the display controller 220 may display the internal maps for the respective floors of the building without overlapping each other through the display module 150 under the control of the map configuration unit 210.

In addition, the display controller 220 may also magnify and display the internal maps for the respective floors of the building through the display module 150 under the control of the map configuration unit 210. Furthermore, the display controller 220 may also display the internal maps for the respective floors of the building without overlapping each other, together with a moving path through the display module 150 under the control of the map configuration unit 210.

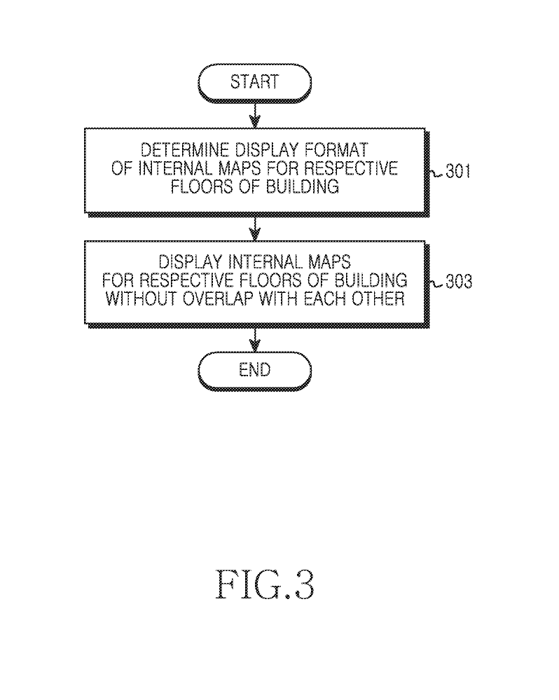

FIG. 3 is a flowchart illustrating a procedure for displaying internal maps for respective floors of a building without overlapping each other in an electronic device according to an embodiment of the present disclosure.

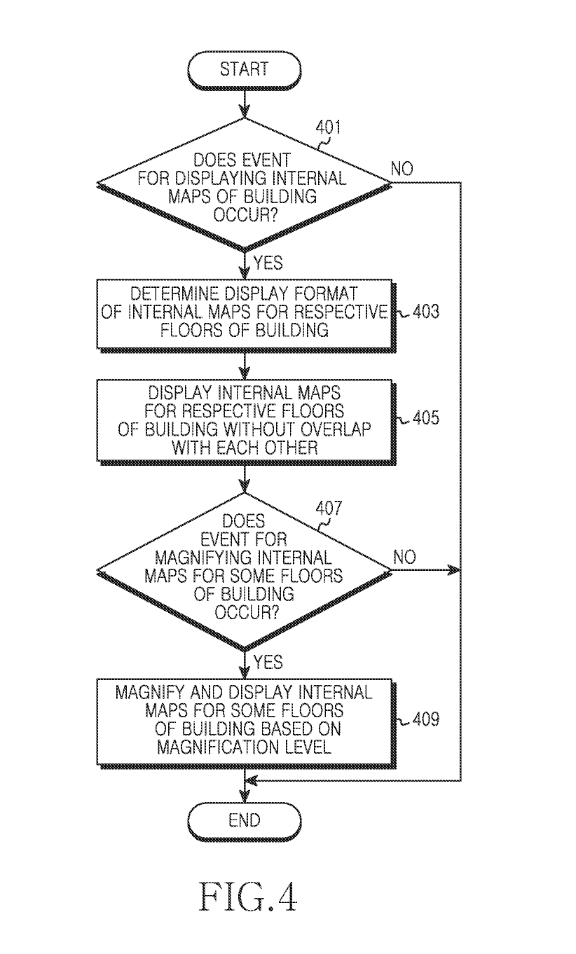

Referring to FIG. 3, a flowchart is illustrated, such that an electronic device may determine a display format of internal maps for respective floors of a building in operation 301. For example, the electronic device may determine the boundary size of the maps based on areas and relative positions of the internal maps for the respective floors of the building. In another example, the electronic device may determine the display format of the internal maps according to tilts of the internal maps for the respective floors of the building. A method of determining a display format of internal maps for respective floors of a building will be described below with reference to FIG. 4.

Thereafter, in operation 303, the electronic device may display the internal maps for the respective floors without overlapping each other. In this case, the electronic device may provide a service for magnifying or moving the displayed internal maps for the respective floors or a path-finding service for the internal maps. A method of providing a magnification, movement, or path-finding service for internal maps of respective floors will be described through various embodiments of the present disclosure.

FIG. 4 is a flowchart illustrating a procedure for magnifying and displaying internal maps for some floors of a building in an electronic device according to an embodiment of the present disclosure.

Referring to FIG. 4, a flowchart is illustrated, such that in operation 401, an electronic device may identify whether an event for displaying internal maps of a building occurs. For example, based on a user's location search, the electronic device may identify whether the event for displaying internal maps of a building occurs. In another example, based on a user's selection of a particular building on a displayed map, the electronic device may identify whether the event for displaying internal maps of a building occurs. In another example, based on a user's selection of a hyperlink mapped with location information of a map, the electronic device may identify whether the event for displaying internal maps of a building occurs.

When the event for displaying internal maps of the building does not occur in operation 401, the process illustrated in FIG. 4 ends.

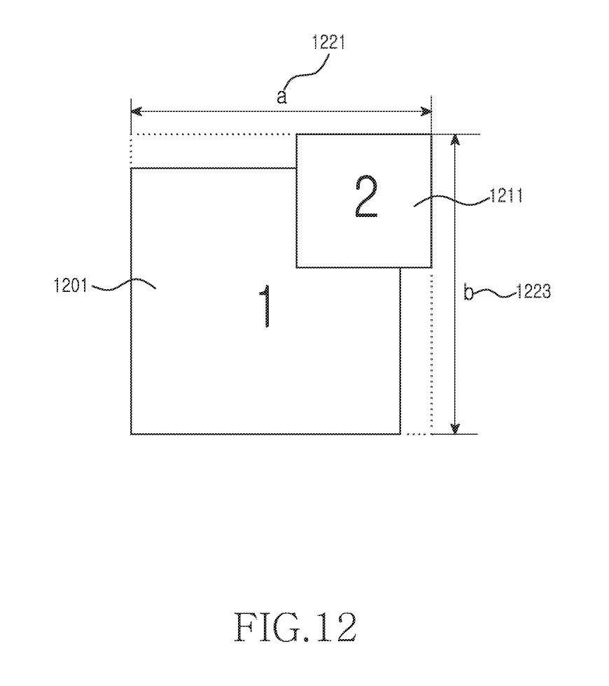

When the event for displaying internal maps of the building occurs, the electronic device may determine a display format of the internal maps for the respective floors of the building in operation 403. For example, the electronic device may determine the boundary size of the maps based on areas and relative positions of the internal maps for the respective floors of the building, as illustrated in FIG. 12.

FIG. 12 illustrates a screen configuration for determining a size of a map boundary based on areas and relative positions of internal maps for respective floors of a building in an electronic device according to an embodiment of the present disclosure.

Referring to FIG. 12, a first floor 1201 and a second 1211 are illustrated, such that when a building is constructed with first floor 1201 and the second floor 1211, the electronic device may determine a horizontal length “a” 1221 and a vertical length “b” 1223 of a map boundary in view of areas and relative positions of the respective floors.

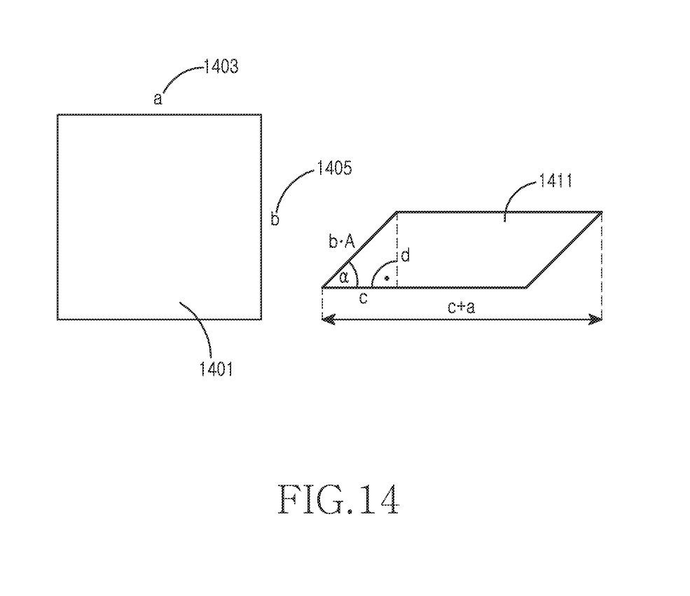

In another example, the electronic device may also determine the display format of the internal maps according to tilts of the internal maps for the respective floors of the building, as illustrated in FIG. 14.

FIG. 14 illustrates a procedure for determining a display format of an internal map according to tilts of internal maps for respective floors of a building according to an embodiment of the present disclosure.

Referring to FIG. 14 a floor 1401 of a building is illustrated, such that when the floor 1401 of the building has a horizontal length “a” 1403 and a vertical length “b” 1405, the electronic device may determine a width “c+a” and a height “d” in view of a tilt α, a length “c” and a magnification factor “A,” by Equation 1 and Equation 2 below as indicated by reference numeral 1411.

height(d)=bEAE sin α Equation 1

width(a+c)=a+bEAE cos α Equation 2

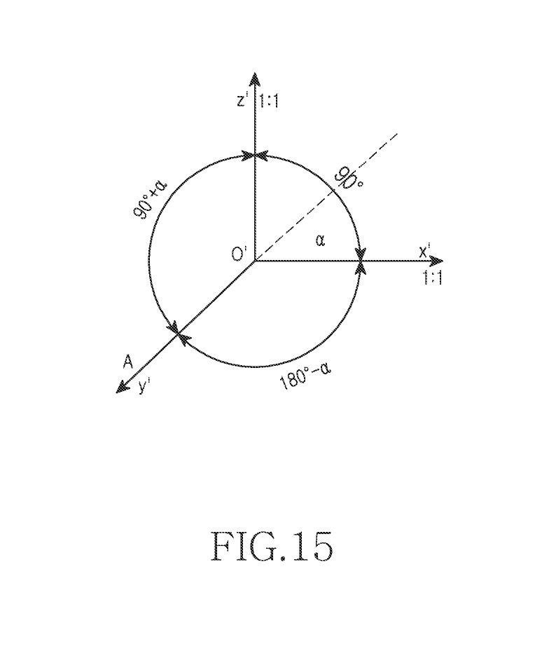

The magnification factor “A” of the Y axis used in Equation 1 and Equation 2 may be determined based on Equation 3 below and FIG. 15.

$$scale ( A ) = \vert 1 - \vert 1 - \frac{αmodπ}{\frac{π}{2}} \vert \vert \qquad Equation 3$$

Here, as shown, FIG. 15 illustrates a procedure for determining a display format of an internal map according to tilts of internal maps for respective floors of a building according to an embodiment of the present disclosure.

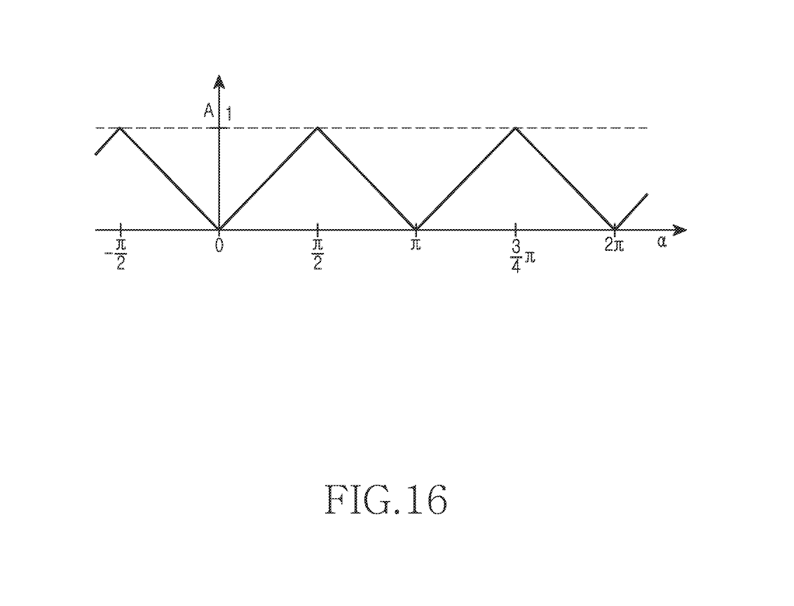

FIG. 16 illustrates a procedure for determining a display format of an internal map according to tilts of internal maps for respective floors of a building according to an embodiment of the present disclosure.

Referring to FIG. 16, a magnification factor “A” is illustrated, such that the magnification factor “A” has a maximum value of “1” and may be determined depending upon the tilt α, as also illustrated in FIG. 14.

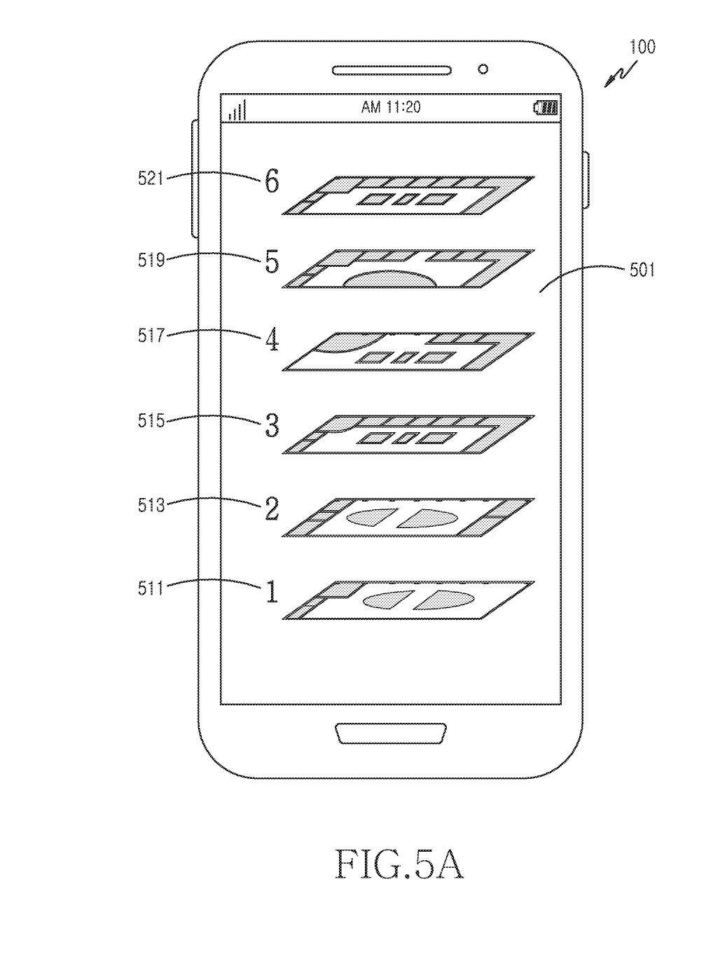

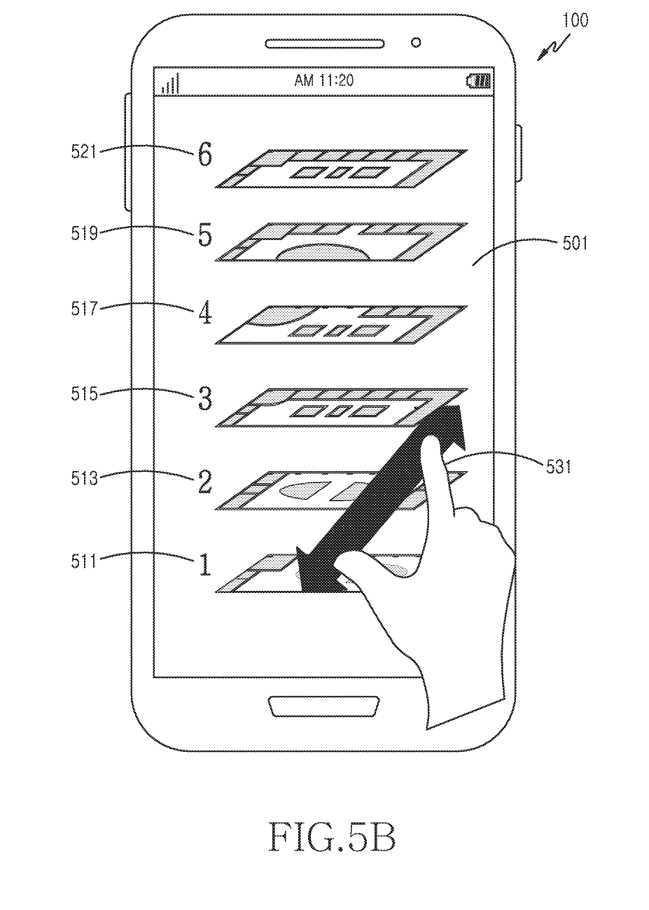

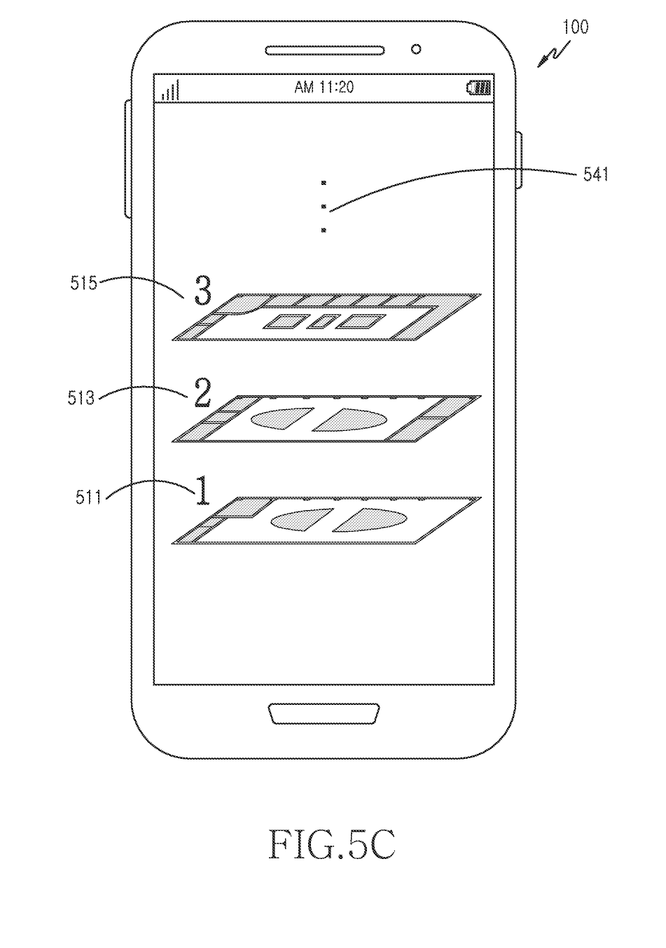

Then, in operation 405, the electronic device may display the internal maps for the respective floors of the building without overlapping each other, as illustrated in FIGS. 5A, 5B and 5C.

FIGS. 5A, 5B and 5C illustrate screen configurations for magnifying and displaying internal maps for some floors of a building in an electronic device according to various embodiments of the present disclosure.

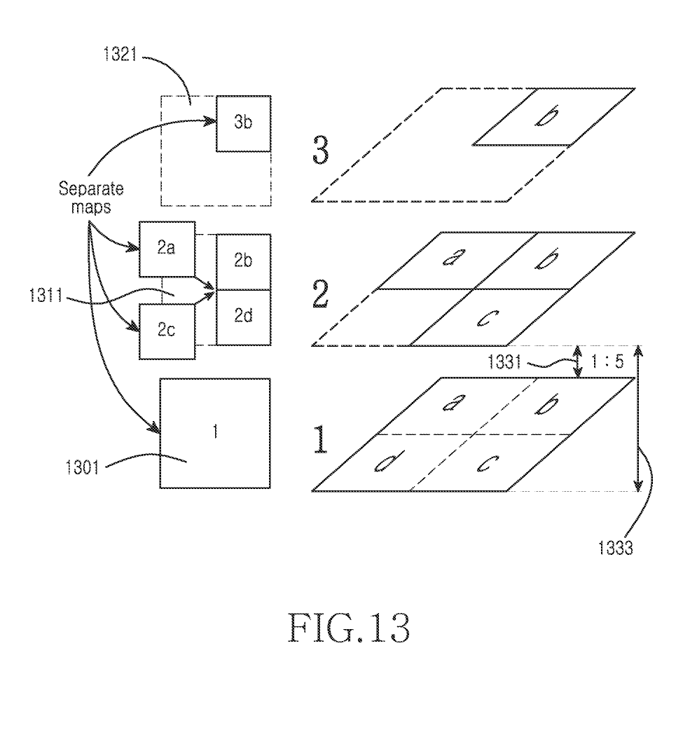

Referring to FIGS. 5A, 5B and 5C, for example, an electronic device 100 may display internal maps 511, 513, 515, 517, 519, and 521 for respective floors of a six-story building as indicated by reference numeral 501. In this case, the electronic device may determine a gap between floors, as illustrated in FIG. 13.

FIG. 13 illustrates a screen configuration for displaying internal maps for respective floors of a building without overlapping each other in an electronic device according to an embodiment of the present disclosure.

Referring to FIG. 13, a first floor 1301, a second floor 1311 and a third floor 1321 are illustrated, wherein a gap between the first floor 1301 and the second floor 1311 in a ratio of 1:5, is indicated by reference numerals 1331 and 1333.

Turning back to FIG. 4, thereafter, in operation 407, the electronic device may identify whether an event for magnifying internal maps for some floors of the building occurs.

Referring to FIG. 5B, for example, the electronic device 100 may identify whether a user's touch gesture 531 on some internal maps occurs. In another example, the electronic device may also identify whether a menu for magnifying a map is selected.

If the event for magnifying internal maps for some floors of the building does not occur in operation 407, the process illustrated in FIG. 4 ends.

If the event for magnifying internal maps for some floors of the building occurs, the electronic device may magnify and display the internal maps for the respective floors of the building based on a magnification level in operation 409. For example, when an event for magnifying the internal maps for the first floor 511 to the third floor 515 occurs by the user's touch gesture 531, as illustrated in FIG. 5B, the electronic device 100 may magnify and display the internal maps for the first floor 511 to the third floor 515, as illustrated in FIG. 5C. In this case, as indicated by reference numeral 541, the electronic device 100 may represent that some floors, which are not displayed, exist above the third floor 515.

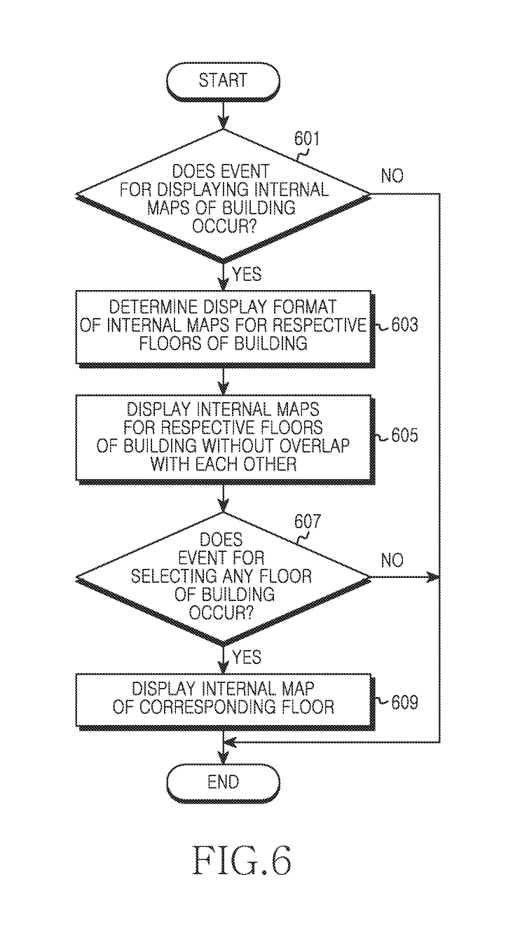

FIG. 6 is a flowchart illustrating a procedure for displaying an internal map for one floor among internal maps for respective floors of a building in an electronic device according to an embodiment of the present disclosure.

Referring to FIG. 6, a flowchart is illustrated, such that in operation 601, an electronic device may identify whether an event for displaying internal maps of a building occurs. For example, based on a user's location search, the electronic device may identify whether the event for displaying internal maps of a building occurs. In another example, based on a user's selection of a particular building on a displayed map, the electronic device may identify whether the event for displaying internal maps of a building occurs. In another example, based on a user's selection of a hyperlink mapped with location information of a map, the electronic device may identify whether the event for displaying internal maps of a building occurs.

When the event for displaying internal maps of the building does not occur in operation 601, the process illustrated in FIG. 6 ends.

When the event for displaying internal maps of the building occurs, the electronic device may determine a display format of the internal maps for the respective floors of the building in operation 603. For example, the electronic device may determine the boundary size of the maps based on areas and relative positions of the internal maps for the respective floors of the building. Specifically, when the building is constructed with the first floor 1201 and the second floor 1211, as illustrated in FIG. 12, the electronic device may determine the horizontal length “a” 1221 and the vertical length “b” 1223 of a map boundary in view of areas and relative positions of the respective floors.

In another example, the electronic device may also determine the display format of the internal maps according to tilts of the internal maps for the respective floors of the building. Specifically, when the floor 1401, as illustrated in FIG. 14, of the building has the horizontal length “a” 1403 and the vertical length “b” 1405, the electronic device may determine the width “c+a” and the height “d” in view of the tilt α by Equation 1 and Equation 2 as indicated by reference numeral 1411. The magnification factor “A,” as illustrated in FIGS. 14 and 16, of the Y axis used in Equation 1 and Equation 2 may be determined based on Equation 3 and FIG. 15. Here, the magnification factor “A” has the maximum value of “1” as illustrated in FIG. 16 and may be determined depending upon the tilt α.

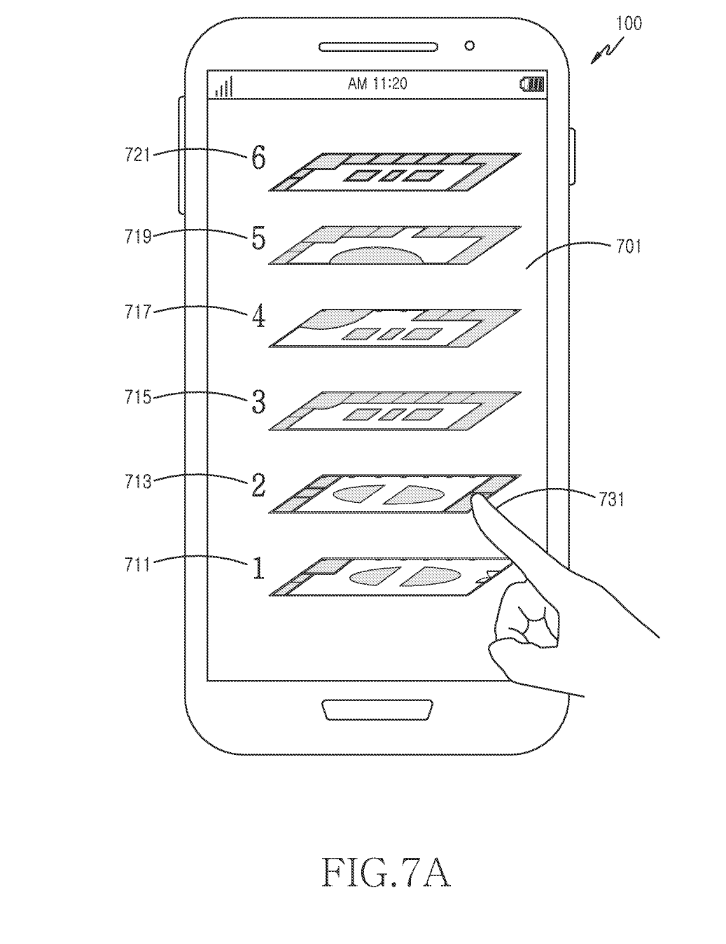

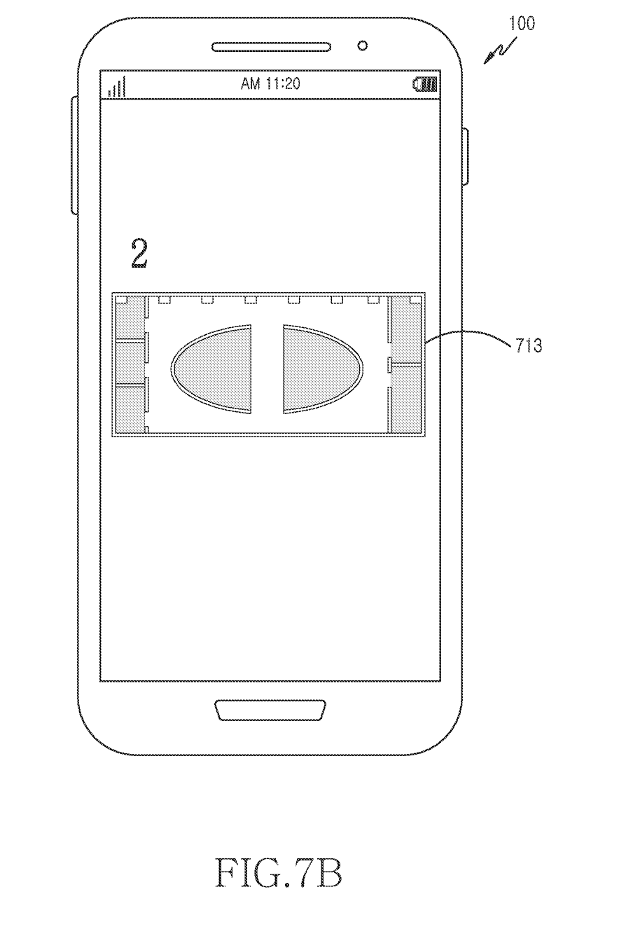

Then, in operation 605, the electronic device may display the internal maps for the respective floors of the building without overlapping each other, as illustrated, for example, in FIG. 7A.

FIG. 7A illustrates a screen configuration for displaying an internal map for any floor among internal maps for respective floors of a building in an electronic device according to an embodiment of the present disclosure.

Referring to FIG. 7A, for example, an electronic device 100 is illustrated, where the electronic device 100 may display internal maps 711, 713, 715, 717, 719, and 721 for respective floors of a six-story building as indicated by reference numeral 701. In this case, the electronic device 100 may determine the gap between the first floor 1301 and the second floor 1311 in the ratio of 1:5 as indicated by reference numerals 1331 and 1333 of FIG. 13.

Thereafter, in operation 607, the electronic device may identify whether an event for selecting any floor of the building occurs. For example, referring to FIG. 7A, the electronic device may identify whether a user's touch gesture 731 for any floor of the building occurs. In another example, the electronic device may also identify whether a menu for selecting any floor of the building is selected.

If the event for selecting any floor of the building does not occur in operation 607, the process illustrated in FIG. 6 ends.

If the event for selecting any floor of the building occurs, the electronic device may magnify and display the internal map for the selected floor in operation 609, as illustrated, for example, in FIG. 7B.

FIG. 7B illustrates a screen configuration for displaying an internal map for any floor among internal maps for respective floors of a building in an electronic device according to an embodiment of the present disclosure.

Referring to FIG. 7B, for example, an electronic device 100 is illustrated, such that when a user selects the second floor as illustrated in FIG. 7A, the electronic device 100 may magnify and display the internal map 713 for the second floor as illustrated in FIG. 7B. Additionally, when a drag occurs on the internal map 713 for the second floor, the electronic device 100 may display the internal map for the first or the third floor based on the drag direction.

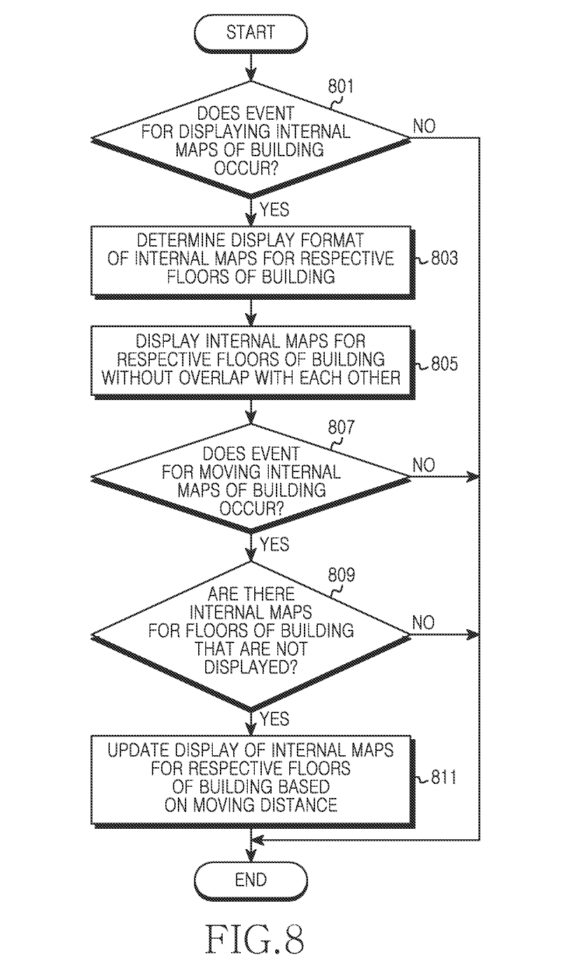

FIG. 8 is a flowchart illustrating a procedure for controlling a movement of internal maps for respective floors of a building in an electronic device according to an embodiment of the present disclosure.

Referring to FIG. 8, a flowchart is illustrated, such that in operation 801, an electronic device may identify whether an event for displaying internal maps of a building occurs. For example, based on a user's location search, the electronic device may identify whether the event for displaying internal maps of a building occurs. In another example, based on a user's selection of a particular building on a displayed map, the electronic device may identify whether the event for displaying internal maps of a building occurs. In another example, based on a user's selection of a hyperlink mapped with location information of a map, the electronic device may identify whether the event for displaying internal maps of a building occurs.

When the event for displaying internal maps of the building does not occur in operation 801, the process illustrated in FIG. 8 ends.

When the event for displaying internal maps of a building occurs, the electronic device may determine a display format of the internal maps for the respective floors of the building in operation 803. For example, the electronic device may determine the boundary size of the maps based on areas and relative positions of the internal maps for the respective floors of the building. Specifically, when the building is constructed with the first floor 1201 and the second floor 1211 as illustrated in FIG. 12, the electronic device may determine the horizontal length “a” 1221 and the vertical length “b” 1223 of a map boundary in view of areas and relative positions of the respective floors.

In another example, the electronic device may also determine the display format of the internal maps according to tilts of the internal maps for the respective floors of the building. Specifically, when the floor 1401 of the building has the horizontal length “a” 1403 and the vertical length “b” 1405, as illustrated in FIG. 14, the electronic device may determine the width “c+a” and the height “d” in view of the tilt α by Equation 1 and Equation 2 as indicated by reference numeral 1411. The magnification factor “A,” as illustrated in FIG. 14, of the Y axis used in Equation 1 and Equation 2 may be determined based on Equation 3 and FIG. 15. Here, the magnification factor “A” has the maximum value of “1” as illustrated in FIG. 16 and may be determined depending upon the tilt α.

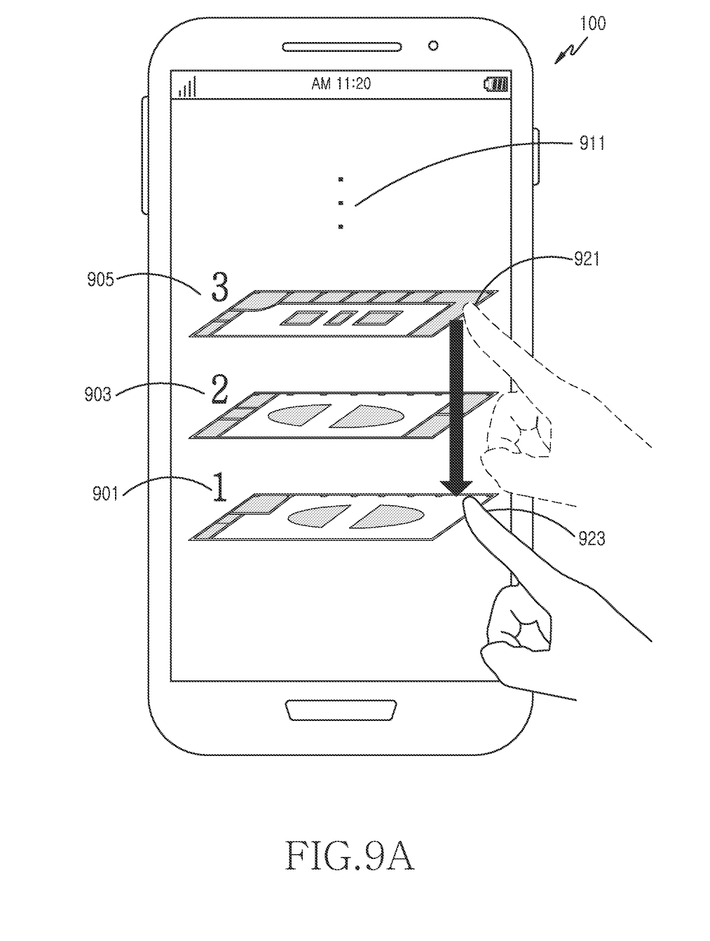

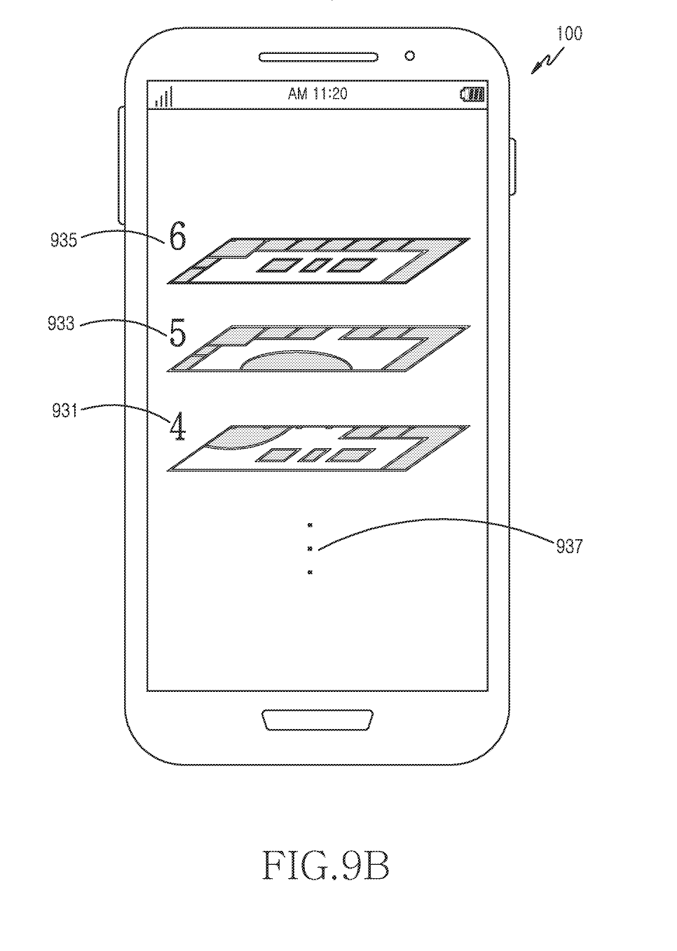

Then, in operation 805, the electronic device may display the internal maps for the respective floors of the building without overlapping each other, as illustrated in FIGS. 9A and 9B.

FIGS. 9A and 9B illustrate screen configurations for controlling movement of internal maps for respective floors of a building in an electronic device according to various embodiments of the present disclosure.

Referring to FIG. 9A, for example, an electronic device 100 may display internal maps 901, 903, and 905 for some floors of a six-story building as illustrated in FIG. 9A. In this case, as indicated by reference numeral 911, the electronic device 100 may represent that some floors which are not displayed exist above the third floor. In this case, the electronic device 100 may determine the gap between the first floor 1301 and the second floor 1311 in the ratio of 1:5 as indicated by reference numerals 1331 and 1333 of FIG. 13.

Thereafter, in operation 807, the electronic device may identify whether an event for moving the internal maps of the building occurs. For example, the electronic device 100 may identify whether a user's drag from a first point 921 to a second point 923 on the maps occurs, as illustrated in FIG. 9A. In another example, the electronic device may also identify whether a menu for selecting movement of the internal maps of the building is selected.

If the event for moving the internal maps of the building does not occur in operation 807, the process illustrated in FIG. 8 ends.

If the event for moving the internal maps of the building occurs, the electronic device may identify, in operation 809, whether there are internal maps for floors of the building which are not displayed.

If there are not internal maps for the floor of the building that are not displayed, the process illustrated in FIG. 8 ends.

If there are internal maps for floors of the building which are not displayed, the electronic device may update the displaying of the internal maps for the respective floors of the building based on a moving distance in operation 811. For example, when the user's drag from the first point 921 to the second point 923 on the maps occurs, as illustrated in FIG. 9A, the electronic device 100 may display internal maps 931, 933, and 935 for the floors which are not displayed among all the floors of the six-story building, as illustrated in FIG. 9B. In this case, as indicated by reference numeral 937, the electronic device 100 may represent that some floors which are not displayed exist below the fourth floor.

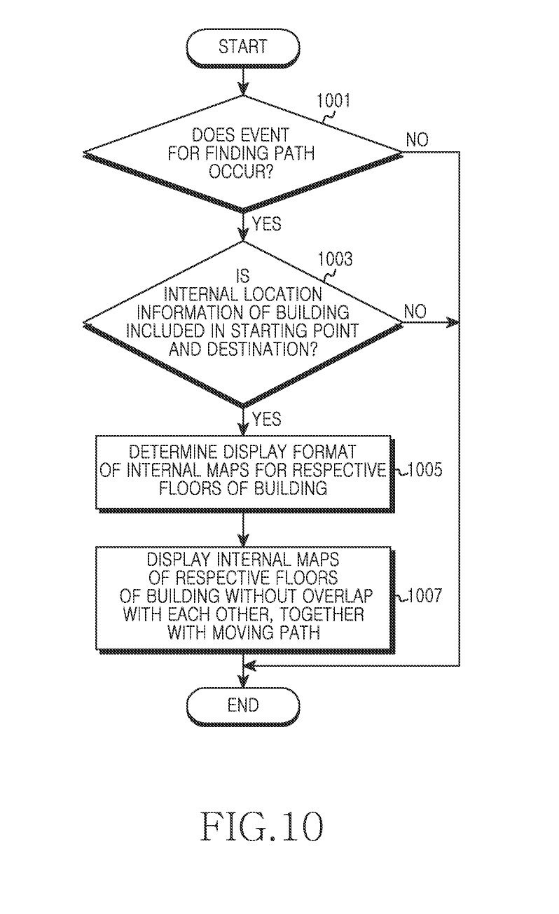

FIG. 10 is a flowchart illustrating a procedure for displaying internal maps for respective floors of a building together with a moving path in an electronic device according to an embodiment of the present disclosure.

Referring to FIG. 10, a flowchart is illustrated, such that in operation 1001, an electronic device may identify whether an event for finding a path occurs.

If the event for finding the path does not occur in operation 1001, the process illustrated in FIG. 10 ends.

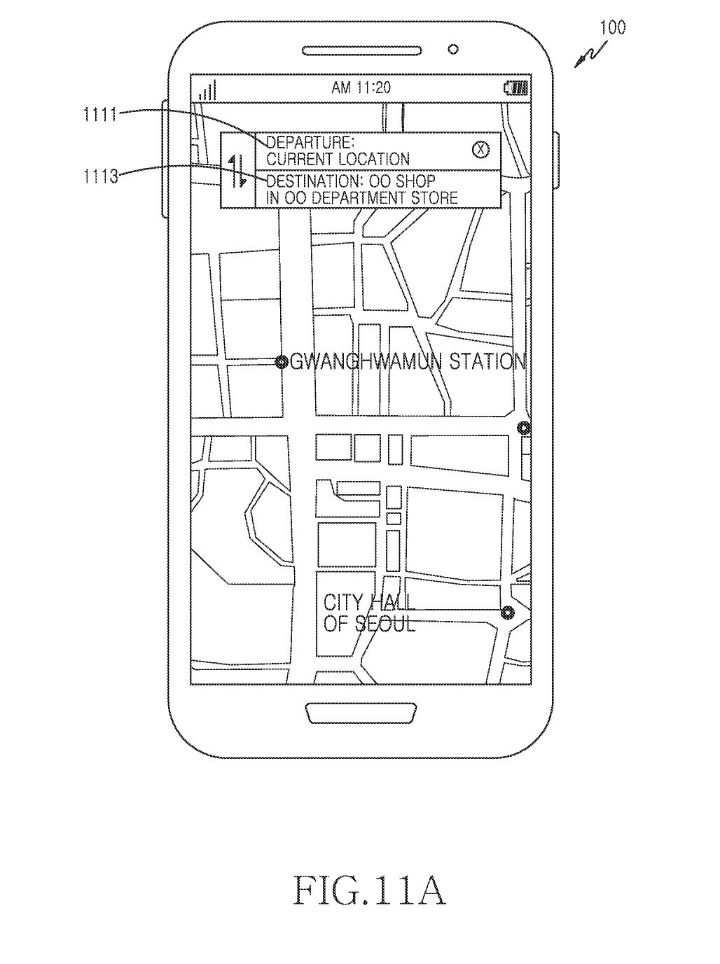

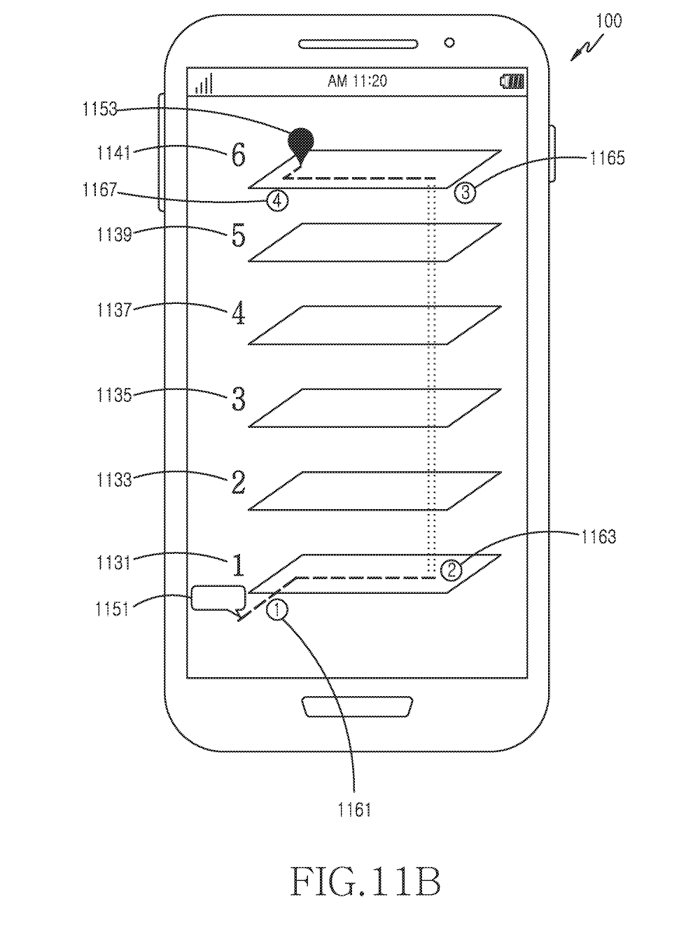

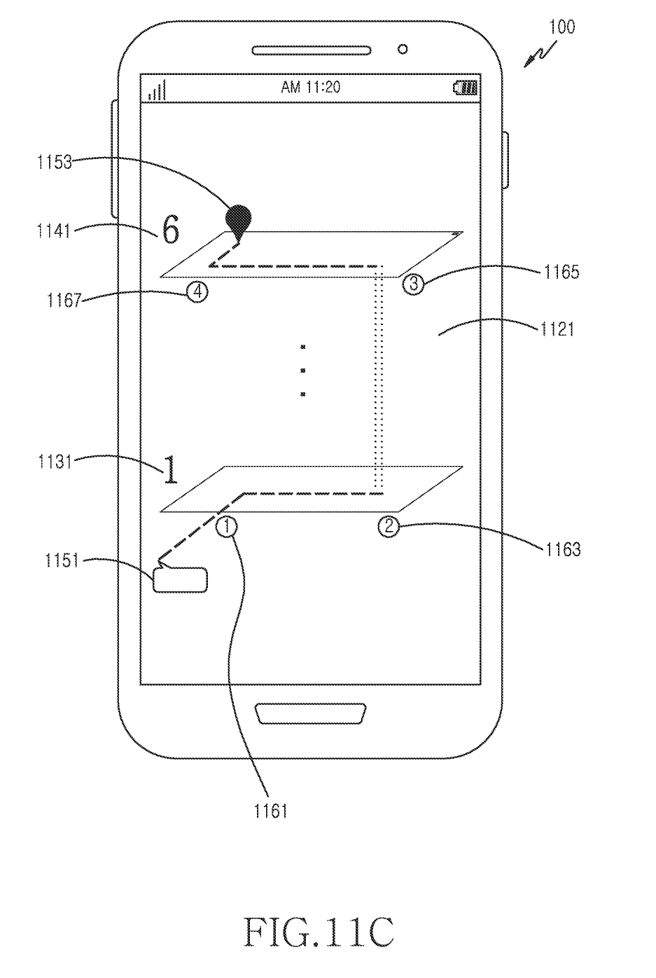

If the event for finding the path occurs, the electronic device may identify, in operation 1003, whether a starting point or destination includes internal location information of a building, as illustrated, for example, in FIGS. 11A, 11B and 11C.

FIGS. 11A, 11B, and 11C illustrate screen configurations for displaying internal maps for respective floors of a building together with a moving path in an electronic device according to various embodiments of the present disclosure.

Referring to FIG. 11A, for example, an electronic device 100 is illustrated, such that when an event for finding a path from a starting point 1111 “current location” to a destination 1113 “oo shop in oo department store” occurs, the electronic device 100 may identify whether a building having internal maps is included in “current location” and “oo shop in oo department store”. Additionally, the electronic device 100 may identify whether a building having internal maps is among buildings on the path from the starting point to the destination, in addition to the starting point and the destination.

If the starting point or the destination does not include the internal location information of the building, the process illustrated in FIG. 10 ends.

If the starting point or the destination includes the internal location information of the building, the electronic device may determine a display format of internal maps for respective floors of the building in operation 1005. For example, the electronic device may determine the boundary size of the maps based on areas and relative positions of the internal maps for the respective floors of the building. Specifically, when the building is constructed with the first floor 1201 and the second floor 1211 as illustrated in FIG. 12, the electronic device may determine the horizontal length “a” 1221 and the vertical length “b” 1223 of a map boundary in view of areas and relative positions of the respective floors.

In another example, the electronic device may also determine the display format of the internal maps according to tilts of the internal maps for the respective floors of the building. Specifically, when the floor 1401 of the building has the horizontal length “a” 1403 and the vertical length “b” 1405, as illustrated in FIG. 14, the electronic device may determine the width and the height in view of the tilt α by Equation 1 and Equation 2 as indicated by reference numeral 1411. The magnification factor “A” of the Y axis used in Equation 1 and Equation 2 may be determined based on Equation 3 and FIG. 15. Here, the magnification factor “A” has the maximum value of “1” as illustrated in FIG. 16 and may be determined depending upon the tilt α.

Then, in operation 1007, the electronic device may display the internal maps for the respective floors of the building without overlapping each other, together with a moving path.

Referring to FIG. 11B, for example, an electronic device 100 is illustrated, where the electronic device 100 may display internal maps 1131, 1133, 1135, 1137, 1139, and 1141 for respective floors of a six-story building which include a path from a starting point 1511 to a destination 1153. The electronic device 100 may also display first to fourth points 1161, 1163, 1165, and 1167, including particular information, on the path from the starting point 1151 to the destination 1153. Here, the particular information may include at least one of an exit, an elevator, an escalator, stairs, a crosswalk, and a turning point. In this case, the electronic device 100 may determine the gap between the first floor 1301 and the second floor 1311 in the ratio of 1:5 as indicated by reference numerals 1331 and 1333, as illustrated in FIG. 13.

Referring to FIG. 11B, some floors which do not include particular information (the second to fifth floors) may exist on the path from the starting point 1151 to the destination 1153, as illustrated, for example, in FIG. 11C.

Referring to FIG. 11C, an electronic device 100 and reference numeral 1121 are illustrated, where the electronic device 100 may magnify and display the floors including particular information (the first and sixth floors), except for the floors which do not include particular information (the second to fifth floors), on the path from a starting point 1151 to a destination 1153. Specifically, FIG. 11C illustrates internal maps 1131 and 1141, and first to fourth points 1161, 1163, 1165 and 1167 on the path from the starting point 1151 to the destination 1153.

As described above, the electronic device 100 may display internal maps of respective floors of a building without overlapping each other, thereby enabling users thereof to easily identify internal structures of the respective floors included in the building.

Methods according to various embodiments of the present disclosure disclosed in claims and/or the specification may be implemented in the form of hardware, software, or a combination thereof.

In cases where the methods are implemented in the form of software, a computer readable storage medium may be provided for storing one or more programs (software modules). One or more programs stored in the non-transitory computer readable storage medium are configured to be executed by one or more processors in an electronic device. The one or more programs may include instructions for allowing the electronic device to carrying out the methods according to the various embodiments of the present disclosure disclosed in the claims and/or the specification.

The programs (software modules or software) may be stored in a Random Access Memory (RAM), a non-volatile memory including a flash memory, a Real Only Memory (ROM), an Electrically Erasable Programmable ROM (EEPROM), a magnetic disc storage device, a Compact Disc-ROM (CD-ROM), a DVD or other types of optical storage devices, or a magnetic cassette. Alternatively, the programs may be stored in a memory that is configured of a combination of all or some thereof. In addition, a plurality of constituent memories may also be included.

Furthermore, the programs may be stored in an attachable storage device that is accessible through a communication network such as the Internet, the Intranet, a LAN, Wide LAN (WLAN), or Storage Area network (SAN), or a communication network configured of a combination thereof. The storage devices may be connected to an electronic device through an external port.

Moreover, a separate storage device in a communication network may also be connected to a portable electronic device.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of an electronic device configuring a map, the method comprising:
determining, by one or more processors of the electronic device, a display format of internal maps for respective floors of a building when an event for displaying the internal maps of the building constructed with multiple floors occurs; and
displaying the internal maps for the respective floors of the building without overlapping each other based on the determined display format.

2. The method of claim 1, wherein the determining of the display format of the internal maps for the respective floors of the building comprises:
determining tilts of the internal maps for the respective floors of the building.

3. The method of claim 1, wherein the determining of the display format of the internal maps for the respective floors of the building comprises:
determining relative positions of the internal maps for the respective floors of the building.

4. The method of claim 1, further comprising:
displaying an internal map for a selected floor, when one floor is selected from the displayed internal maps for the respective floors of the building.

5. The method of claim 4, further comprising:
displaying an internal map for a floor above or below the selected floor based on a direction of a drag when the drag is generated on the internal map of the selected floor.

6. The method of claim 1, further comprising:
magnifying and displaying internal maps for some floors of the building based on a magnification level when an event for magnifying the internal maps for the respective floors of the building occurs.

7. The method of claim 6, further comprising:
displaying an internal map for a floor above or below displayed floors of the building based on a direction of a drag, when the drag is generated on the magnified internal maps for the floors of the building.

8. The method of claim 1, further comprising:
when an event for finding a path involving the building occurs, displaying the internal maps for the respective floors of the building without overlapping each other, together with a moving path of the event for finding the path.

9. The method of claim 8, further comprising:
cancelling the displaying of the internal images for the floors which are not involved in the moving path among all the floors of the building.

10. The method of claim 8, further comprising:
updating the display of the internal maps based on a moving distance of a user.

11. An electronic device comprising;
a display;
a memory; and
one or more processors configured to:
determine a display format of internal maps for respective floors of a building when an event for displaying the internal maps of the building constructed with multiple floors occurs; and
display, on the display, the internal maps for the respective floors of the building without overlapping each other based on the determined display format.

12. The electronic device of claim 11, wherein the one or more processors are further configured to determine tilts of the internal maps for the respective floors of the building.

13. The electronic device of claim 11, wherein the one of more processors are configured to determine relative positions of the internal maps for the respective floors of the building.

14. The electronic device of claim 11, wherein, when one floor is selected from the internal maps for the respective floors of the building which are displayed on the display, the one or more processors are further configured to display an internal map of the selected floor on the display.

15. The electronic device of claim 14, wherein the one or more processors are further configured to display, on the display, an internal map for a floor above or below the selected floor based on a direction of a drag, when the drag is generated on the internal map of the selected floor.

16. The electronic device of claim 11, wherein the one or more processors are further configured to magnify and display internal maps for some floors of the building through the display based on a magnification level when an event for magnifying the internal maps for the respective floors of the building occurs.

17. The electronic device of claim 16, wherein the one or more processors are further configured to display, through the display, an internal map for a floor above or below displayed floors of the building based on a direction of a drag when the drag is generated on the magnified internal maps for the floors of the building.

18. The electronic device of claim 11, wherein, when an event for finding a path involving the building occurs, the one or more processors are further configured to display, through the display, the internal maps for the respective floors of the building without overlapping each other, together with a moving path of the event for finding the path.

19. The electronic device of claim 18, wherein the one or more processors are further configured to cancel, through the display, the displaying of the internal images for the floors which are not involved in the moving path among all the floors of the building.
